(19) United States
(12) Patent Application Publication
(10) Pub. No.: US 2011/0108329 A1
(43) Pub. Date: May 12, 2011

(54) Inline conveyor scale

(76) Inventor: Christopher Dale, Studley (GB)

(21) Appl. No.: 12/927,915

(22) Filed: Nov. 29, 2010

Related U.S. Application Data
(62) Division of application No. 12/288,608, filed on Oct. 22, 2008.
(60) Provisional application No. 60/981,931, filed on Oct. 23, 2007.

(51) Int. Cl. G01G 9/00

(52) U.S. Cl. 177/1

(57) ABSTRACT

A weighing machine that uses a plurality of pivoting conveyors to deliver product to a plurality of weigh hoppers the sum of which make the desired total weight required for a package. Each pivoting conveyor may supply product to a plurality of secondary conveyors by rotating or changing the pivoting conveyor belt speed. The machine uses a calculated number of front or rear weigh hoppers positioned beneath corresponding accumulation hoppers to produce the desired total weight. The accumulation hopper rapidly fills the weigh hopper after the weigh hopper is emptied. The front and rear accumulation hoppers are positioned below a diverter plate that directs product from the secondary conveyor. Access to the front and rear accumulation and weigh hoppers is made possible by hinging the front set of hoppers.

### CROSS-REFERENCE TO RELATED APPLICATIONS

This is a division of application Ser. No. 12/288,608, Filed 2008 Oct. 22, now abandoned. This divisional application claims the benefit of provisional patent application Ser. No. 60/981,931, Filed 2007 Oct. 23 by the present inventor.

### FEDERALLY SPONSORED RESEARCH

Not Applicable

### SEQUENCE LISTING OR PROGRAM

Not Applicable

### BACKGROUND

1. Field

This application relates to conveying devices, specifically devices used to convey articles to a combination weigher prior to the articles entering a bag making machine.

2. Prior Art

Several methods of conveying and weighing products to package into bags have been developed. These methods primarily focused on providing a more accurate weight of the product in a bag. In industries that package sticky food products such as fresh meat and poultry, radial combination scales have been commonplace, as is shown by U.S. Pat. No. 5,258,580 to Bergholt (1993). One disadvantage of the radial weigher is the space needed around the circumference of the machine to allow for operation and maintenance. Another area that causes problems in packaging industries is the continual feeding of the combination weigher that causes buildup of product when the weigh hoppers are not calling for additional product.

One example of a feeder that may cause buildup of product would be U.S. Pat. No. 4,901,807 to Muskat (1990). Since there is no individual adjustment of the feeding conveyors, product will continue to feed to the accumulating hoppers when the hoppers are not demanding product. Other attempts to accurately feed weighers have been attempted as in U.S. Pat. No. 4,765,488 to Moriarity (1988). Moriarity uses a non-plurality of conveyors to feed multiple hoppers causing a bottle-neck or decrease in feed rate. Feeding devices such as the vibrating feeder in U.S. Pat. No. 5,074,436 to Inoue (1991) are not suited to feeding sticky food product.

U.S. Pat. No. 7,368,670 to Hjálmarsson (2008) provides for an accurate way of weighing product, but does not specify a rapid way of feeding the weighing scales. Additionally, although a corresponding number of endless conveyors, this invention uses a single feeding conveyor to supply product to them. This results in a decreased rate of product feed to the accumulation hoppers.

Product diverters have also been used in certain applications with limited success. The diverters eliminate the need for additional accumulating hoppers above the weigh hoppers. U.S. Pat. No. 4,825,896 to Mikata (1989) use a diverter that is hinged above the diverter plate. This arrangement may cause product coming from the accumulating hopper to fall on the hinge causing a jam of product. Another example is U.S. Pat. No. 4,967,856 to Kawanishi (1990) that uses a single accumulating hopper to feed separate weighing compartments. Using an immovable partition between the weigh hopper areas would also lend itself to jamming of product by creating an additional edge for product to contact. U.S. Pat. No. 4,901,807 to Muskat (1990) also uses compartments, but does allow for a movable accumulating hopper. This accumulating hopper, when full of product, has more mass and is therefore slower to activate than a pivoting diverter plate.

A diverter plate is taught by U.S. Pat. No. 6,388,209 to Gudmundsson (2002) but its construction is not mentioned. Since diverter plate activation speed is essential, it is necessary to have the actuator affixed as close to the plate pivot point as possible. Also, it is also desired to have the upper portion of the diverter free so it will not interfere with the product that will enter the accumulation hopper. For the latter reason, it is necessary to couple the actuator with the diverter plate below the pivot for the plate.

When packaging products such as fresh meat or other irregularly shaped articles, it is also an advantage to quickly free material that may become lodged in the hoppers. To allow quick access to the accumulation and weigh hoppers, the preferred embodiment also uses doors with hinges on either end of the machine. Having two doors to access the rear hoppers allows cleaning and maintenance while not substantially increasing the clearance required in front of the machine. U.S. Pat. No. 4,901,807 to Muskat (1990) uses accumulation and weigh hoppers that are removable but not easily accessed while still in the weigher machine. U.S. Pat. No. 6,437,256 to Miyamoto (2002) offers quicker access to the hoppers while in the machine, but requires a large amount of floor space to accommodate the hoppers in a single rather than a dual plane.

### SUMMARY

In accordance with one embodiment, the inline conveyor scale comprises a plurality of pivoting infeed conveyors, each delivering product as required to two secondary endless conveyors. Each secondary conveyor is supplying product to a corresponding accumulation hopper. Product from the secondary conveyors is diverted to the front or rear accumulation hopper based on demand from the weigh hoppers. Different weigh hoppers empty their respective product based on the total weight needed in the final package.

### DRAWINGS

### Figures

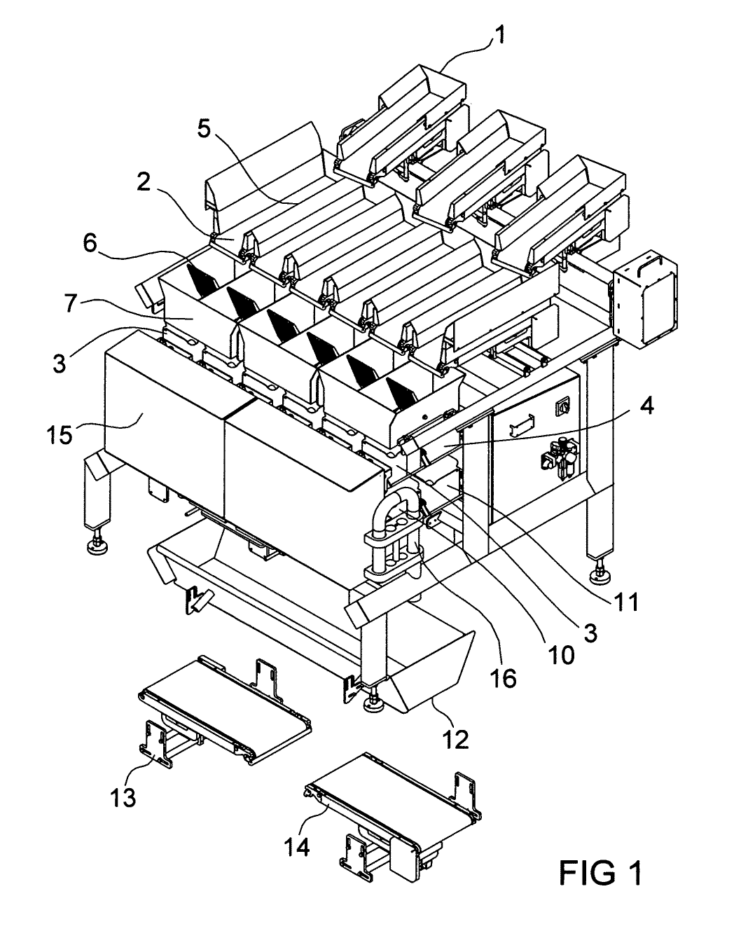

FIG. 1 shows a view of an inline conveyor scale with three infeed conveyors and six secondary conveyors in accordance with one embodiment.

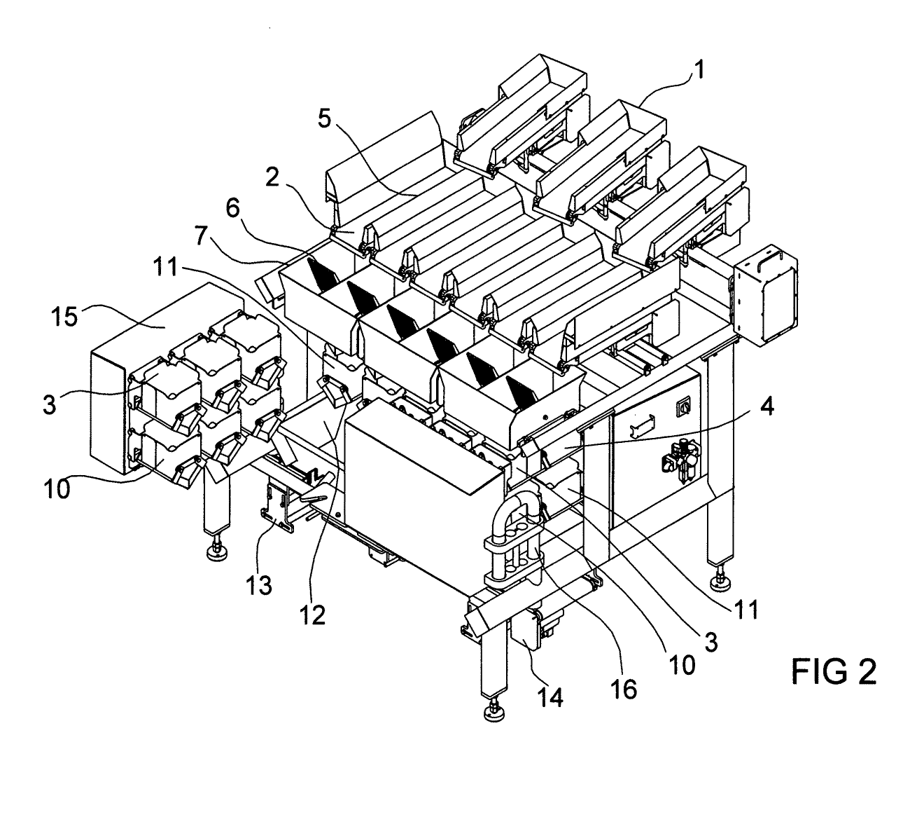

FIG. 2 shows a view of an inline conveyor scale with one of the access doors opened to allow access to the accumulation and weigh hoppers in accordance with one embodiment.

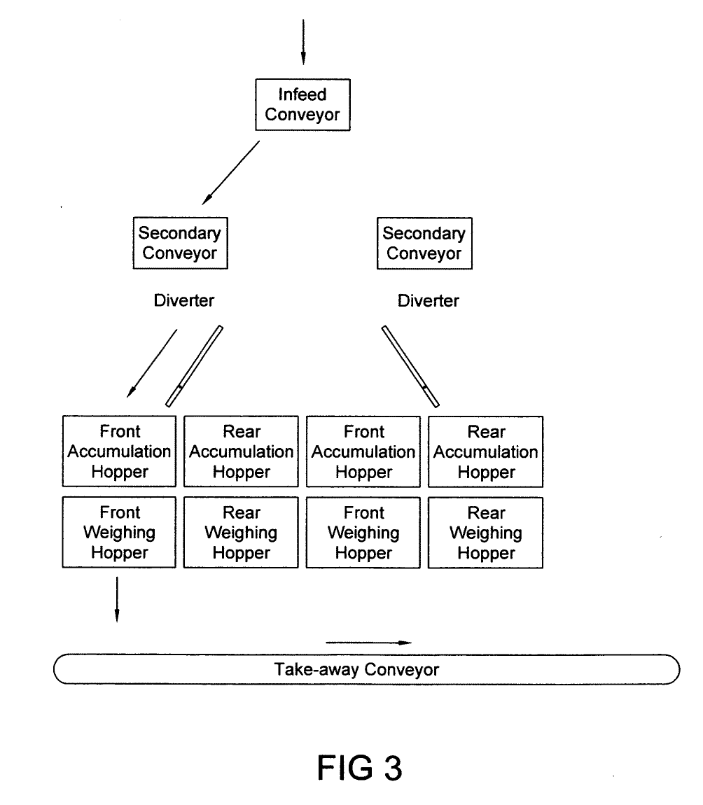

FIG. 3 shows a block diagram representing product feeding through one of the primary conveyors of the machine in accordance with one embodiment.

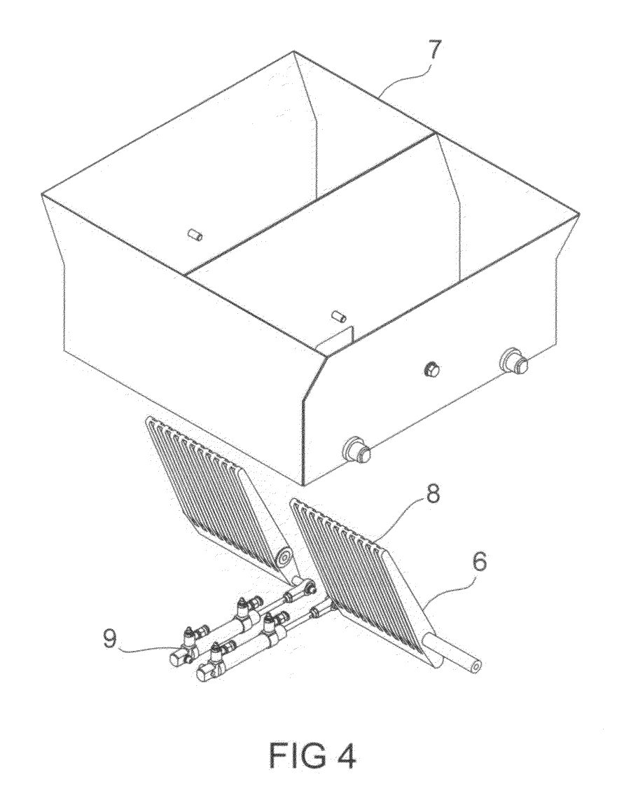

FIG. 4 shows an exploded view of the diverter box and plates in accordance with one embodiment.

DRAWINGS - Reference Numerals

| | | | |
|---|---|---|---|
| 1 | infeed conveyor | 2 | secondary conveyor |
| 3 | front accumulation hopper | 4 | rear accumulation hopper |
| 5 | conveyor shield | 6 | diverter plate |
| 7 | diverter plate housing | 8 | diverter plate grooves |
| 9 | air cylinder | 10 | front weigh hopper |
| 11 | rear weigh hopper | 12 | outfeed guide |
| 13 | left take away conveyor | 14 | right take away conveyor |
| 15 | access door | 16 | hinge |

### DETAILED DESCRIPTION

### FIGS. 1 and 2-First Embodiment

One embodiment of the inline conveyor scale is illustrated in FIGS. 1 and 2. The infeed conveyor 1 transports product to one of two secondary conveyors 2. The speed of both the infeed conveyors 1 and the secondary conveyors 2 are adjusted or stopped based on the need for product in the front accumulation hoppers 3 or rear accumulation hoppers 4. A conveyor shield 5 keeps product from going between the secondary conveyors 2. When the accumulation hoppers 3-4 are full, an electrical signal stops the corresponding secondary conveyor 2 from delivering product. When one or more of the accumulation hoppers 3-4 are emptied, it signals the corresponding secondary conveyors 2 to turn on and increase in speed until product is at the desired level in the accumulation hoppers 3-4. As one of the two secondary conveyors 2 increase in speed, it signals the corresponding infeed conveyors 1 to pivot and/or increase in speed in order to deliver product to secondary conveyor 2 that needs product.

In this embodiment, a diverter plate 6 serves to transfer product from its corresponding secondary conveyor 2 to either the front accumulation hopper 3 or the rear accumulation hopper 4. The diverter plate 6 is located inside the diverter plate housing 7 to keep product from moving around the diverter plate 6 and more effectively directed to the accumulation hoppers 3-4. Grooves 8 are provided in the diverter plate 6 to more effectively channel the product to the front accumulation hopper 3 or rear accumulation hopper 4. When one of the accumulation hoppers 3-4 signal for product, an air cylinder 9 actuates to channel product to the respective accumulation hopper 3-4.

Below the front accumulation hopper 3 or rear accumulation hopper 4 is a corresponding weigh hopper 10-11. The weigh hoppers 10-11 use a loadcell and a computer program to determine the desired amount of product to be held and dispensed. One or more weigh hoppers 10-11 empty through the outfeed guide 12 onto the left take away conveyor 13 or right take away conveyor 14 to make the weight needed for a finished package. The outfeed guide 12 keeps the product from potentially falling off the take away conveyors 13-14.

To perform maintenance or to visually inspect the accumulation hoppers 3-4 or the weigh hoppers 10-11, one or both access doors 15 may be opened. A hinge 16 is positioned at each side of the door to allow the front accumulation hoppers 3 and front weigh hoppers 10 to swing out for inspection.

FIG. 3 illustrates an example in one embodiment of how product may flow from one of the infeed conveyors 1. This illustration just shows one third of the embodiment shown in FIGS. 1-2. Although product may be flowing through one portion of the machine, as indicated with arrows, product is often contained on additional secondary conveyors or in additional hoppers awaiting a signal to make a final total package weight and discharge product from certain weigh hoppers.

I claim:

1. A method of automatically transporting and weighing a predetermined amount of food product comprising:
a. a plurality of primary endless conveyors pivotably mounted to transport and selectively discharge said food product;
b. a plurality of non-traversing secondary conveyors, the longitudinal axis of said secondary conveyors being substantially parallel to one another and having an upper food contact surface below the upper food contact surface of said primary endless conveyor to transport and selectively discharge said food product from said primary endless conveyors;
c. a corresponding pivotally mounted diverting means, the pivoting axis of said diverting means located substantially below the distal end of said secondary conveyor to direct said food product;
d. a plurality of accumulation hoppers, said accumulation hoppers comprising a single chamber for containing and discharging a predetermined amount of said food product; and
e. a plurality of weighing hoppers, each of said weighing hoppers located below a corresponding number of said accumulation hoppers, and said weighing hoppers each comprising a single weighing chamber for containing and discharging a predetermined amount of said food product, whereby a fraction or total of said predetermined amount of said food product is discharged to a conveyor, bag making machine, or the like.

2. The method of claim 1 wherein said primary endless conveyors pivot independently from other said primary endless conveyors.

3. The method of claim 1 wherein said diverting means is a substantially dihedral plate and contains a plurality of longitudinal grooves on both sides.

4. The method of claim 1 wherein the number of said accumulation hoppers is equal to the number of said weigh hoppers.

5. The method of claim 1 wherein frontal sets of said accumulation hoppers and said weigh hoppers are mounted on common hinges for access to distal sets of said accumulation hoppers and said weigh hoppers.
